(19) United States
(12) Patent Application Publication
(10) Pub. No.: US 2005/0247851 A1
(43) Pub. Date: Nov. 10, 2005

(54) Molded pad for mounting electrical equipment

(76) Inventors: Seth S. Kessler, Cambridge, MA (US); Paul Tannenbaum, Arlington, MA (US)

Correspondence Address: Iandiorio & Teska, 260 Bear Hill Road, Waltham, MA, 02451-1018, US

(21) Appl. No.: 10/839,477

(22) Filed: May 5, 2004

(51) Int. Cl. F16M 1/00

(52) U.S. Cl. 248/678; 248/346.01

(57) ABSTRACT

A molded pad for mounting electrical equipment including a platform of a first material having one surface for carrying electrical equipment; and at least one reinforcing element of a second material integrally molding in the platform for increasing the stiffness and bending strength of said platform.

### FIELD OF THE INVENTION

This invention relates to an improved molded reinforced pad for mounting electrical equipment and to an overmolding method of integrally forming at least partially encapsulating the reinforcing elements.

### BACKGROUND OF THE INVENTION

Pads serve as structural platforms to support transformers for the utility industry. Typically, these pads are manufactured by compression molding, spray-up of chopped glass fibers (normally without robotics), molding of polymer resin concrete, rotational molding of High Density Polyethylene (HDPE) or pouring concrete forms. These methods can yield parts that are often quite heavy, and parts made by spray-up methods can vary in thickness and quality.

The principal function of the pad is to provide a foundation to support the weight of a transformer. The pad must be rigid to reduce deformation under the load of a transformer, durable to maintain its integrity through seasonally harsh environments, and safe to surrounding inhabitants. A pad must also provide a flat rigid surface for mounting and fastening electrical components.

There are several common ways of producing transform pad: compression molding of glass perform or sheet molding compound, spray-up of glass chopped fibers; die molding of polymer resin concrete rotational molding of HDPE and injection molding of structural foam. Arguably, the best current product (based on cost, weight and strength ratios) is manufactured by the compression molding of fiberglass with a polyester binder. This process nets the highest glass content for the highest stiffness, and uses a closed mold yielding the most consistently accurate wall thickness. This accuracy produces a part that requires less post-machining and trimming processes, which lowers the manufacturing and labor costs. Spray-up methods have more flexibility in production, however this process results in much more variability in fiber distribution throughout the structure potentially leading to an unsafe final product. Structural foam parts have good dimension stability, however they are difficult to mold less than 6 mm thick, so volume must be compromised. Also, without reinforcing fibers foam parts tend to creep over time. Concrete and polymer concrete products produce very still products, but add significant weight and installation time. Compression molding has the additional benefits of rapid production times and permanent UV protection that is chemically introduced into the resin. Typical spray-up and some polymer resin concrete designs have a gel coating applied on the external surface to provide UV protection. This can be dangerous if the coating is scratched or wears away, since then the exposed material can quickly decay in normal environmental conditions. Polymer resin concrete without protection may lose 25% of its stiffness in a period of about year in normal sunlight. This material can lose over 35% of its strength in half a year in wet and salty conditions, and suffers similar losses with certain acid exposures.

### BRIEF SUMMARY OF THE INVENTION

It is therefore an object of this invention to provide an improved molded reinforced pad for mounting electrical equipment.

It is a further object of this invention to provide an improved molded reinforced pad for mounting electrical equipment in which the reinforcing elements are integrally formed and at least partially encapsulated.

It is a further object of this invention to provide an improved molded reinforced pad for mounting electrical equipment which is lightweight, strong, durable, and consistent in quality and uniform in thickness.

It is a further object of this invention to provide an improved molded reinforced pad for mounting electrical equipment to minimize deflection due to bending.

It is a further object of this invention to provide an improved molded reinforced pad for mounting electrical equipment which saves as much as 50% weight over fiberglass construction and 90% over concrete.

It is a further object of this invention to provide an improved overmolding method of forming a pad for carrying electrical equipment in which the reinforcing elements are integrally formed and at least partially encapsulated.

The invention results from the realization that an improved molded pad for mounting electrical equipment which is lightweight, strong, durable, can be achieved by integrally molding the reinforcing elements into the pad platform to increase the bending stiffness and overall strength.

This invention features a molded pad for mounting electrical equipment including a platform of a first material having one surface for carrying electrical equipment. There is at least one reinforcing element of a second material integrally molded in the platform for increasing the stiffness and bending strength of platform.

In a preferred embodiment the reinforcing element may have a higher elastic modulus E and tensile strength σ than the platform. The support section may include a rib structure on the other surface of the platform with the at least one reinforcing element disposed in the rib structure. The reinforcing element may include a first portion anchored in the platform and a second portion extending beyond the other surface of the platform. The at least one reinforcing element may be over molded and at least partially encapsulated within the platform. The reinforcing element may have a modulus of elasticity E and of tensile strength σ approximately two times or more than that of the platform. The reinforcing element may have a modulus of elasticity E and of tensile strength σ approximately ten times or more than that of the platform. There may be an array of reinforcing elements, the rib structure may include a matrix of ribs and the array of reinforcing elements may be disposed therein. The first material may include one of a group consisting of thermoset plastics and thermoplastics. The first material may be fiber reinforced. The first material may include filler material. The second material may include one other group consisting of thermoset plastics, thermoplastics, aluminum, kevlar epoxy and graphite epoxy. The reinforcing element may be spaced from the one surface to increase bending stiffness.

The invention also features an overmolding method of forming a pad for mounting electrical equipment including installing at least one reinforcing element in a mold and adding a molding compound to form a platform. The mold is then compressed to over mold and integrally form and at least partially encapsulate the reinforcing element in the platform.

In a preferred embodiment the mold may be a compressive match metal mold.

### BRIEF DESCRIPTION OF THE DRAWINGS

Other objects, features and advantages will occur to those skilled in the art from the following description of a preferred embodiment and the accompanying drawings, in which:

FIG. 1 is a top three dimensional view of a pad according to this invention.

FIG. 2 is a bottom three dimensional view of the pad of FIG. 1.

FIG. 3 is a portion of the sectional-view of taken along lines 3-3 of FIG. 2.

FIG. 4 is a schematic side, sectional view of the platform of FIGS. 1-3 illustrating other locations for reinforcing elements in the platform;

FIG. 5 is a schematic side, sectional view of another embodiment of FIGS. 1-3 illustrating the invention.

FIG. 6-8 are schematic plan views of various forms of reinforcing elements according to this invention.

FIG. 9 is a side elevational view of a mold illustrating the overmolding method of this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

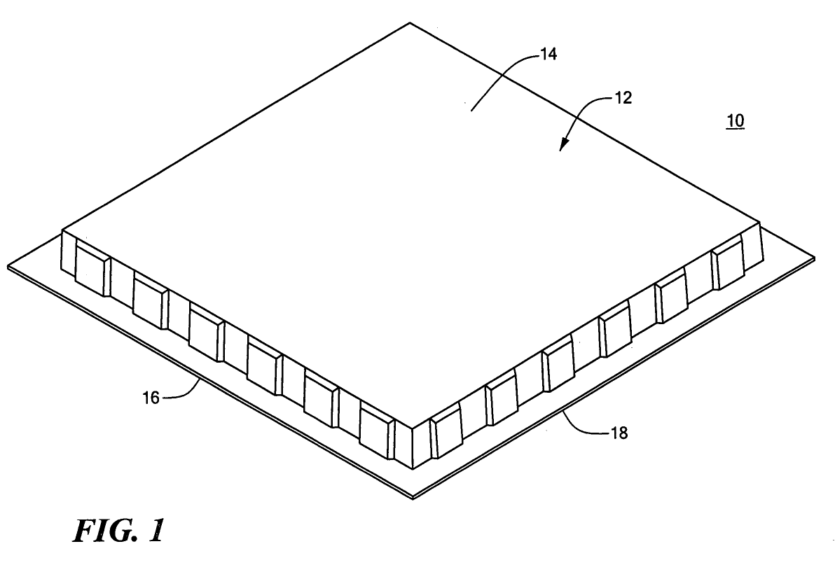

There is shown in FIG. 1 an improved molded reinforced pad 10 including a platform 12 which includes a surface 14 for mounting electrical equipment and a wall 16 which may be corrugated for extra strength. There may be an extended base section 18 as well.

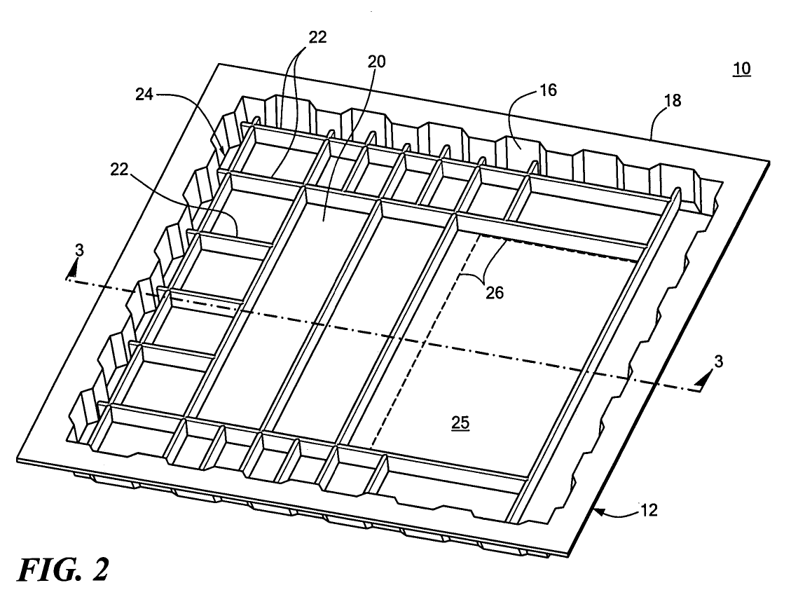

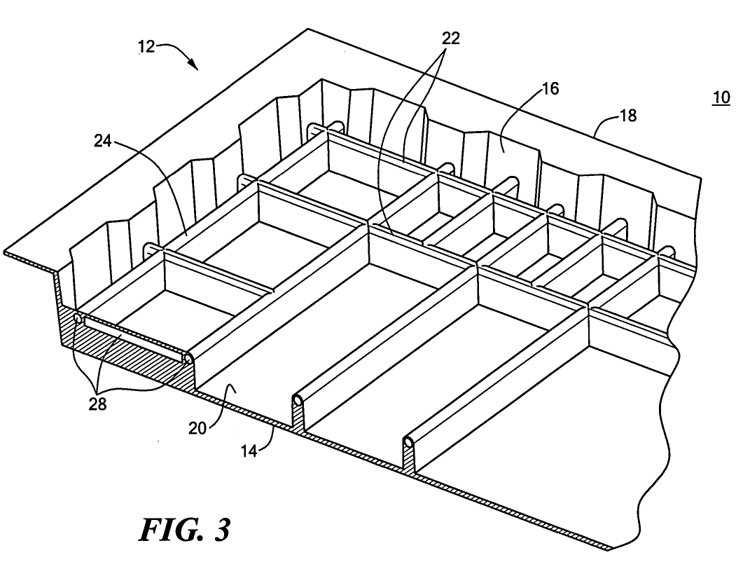

The other surface 20, FIG. 2, on the side from surface 14 includes at least one or more ribs 22 and in fact as shown includes an array 24 of ribs, which extend prominently from surface 20. Also in surface 20 is a opening 25 defined by break lines 26 which may be broken away and even enlarged to bring cables up to the electrical equipment mounted on top surface 14. Ribs 22 of array 24 may each carry a reinforcing element 28, FIG. 3, which has a higher elastic modulus E and tensile strength σ than the platform itself. This increases the stiffness and bending strength of the platform. The modulus of elasticity E and the tensile strength a of the reinforcing elements 28 are at least two times greater than that of platform 12 and preferably are greater by a factor often or more. The material of the platform may be a thermoset plastic or thermoplastic, for example it may be a recycled co-polymer or homopolymer thermoplastic having an E from 100,000 psi to 150,00 psi and a from 5,000 to 8,000 psi. The platform material may be fiber reinforced using glass, carbon or Kevlar for improved strength. It may use a filler material, such as calcium carbonate or calcium sulfate to provide greater stiffness. The second material may include thermoset plastic, thermoplastic, and/or other materials such as aluminum, Kevlar, epoxy, graphite epoxy. A typical material may be a fiberglass filled thermoset plastic where E is greater than 2,000,000 psi and σ is greater than 40,000 psi. The greater the distance that reinforcing element 28 is spaced from surface 14, the greater will be the resistance to bending. Bending resistance is a function of the stiffness of the material as well as the distance between the reinforcing element and the surface in the nature of an I-beam. Typical spacing is 13-15 mm.

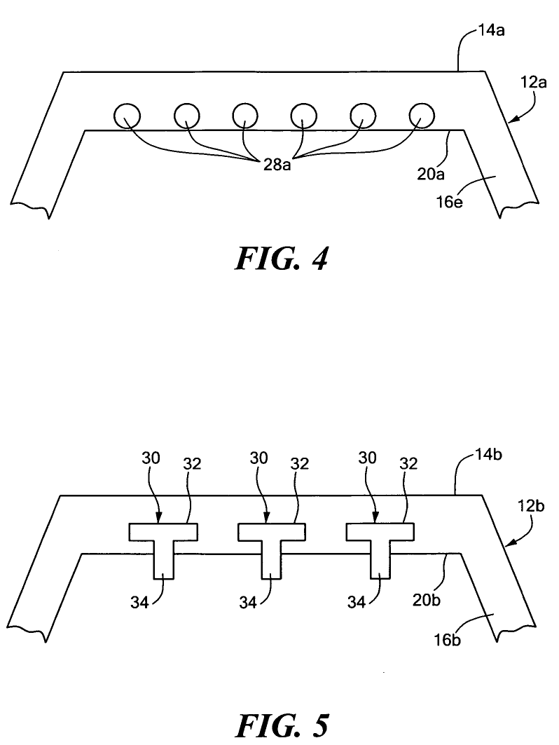

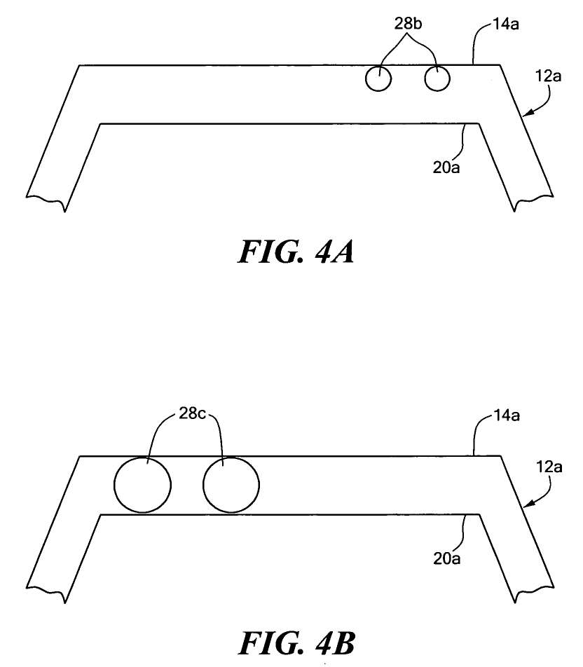

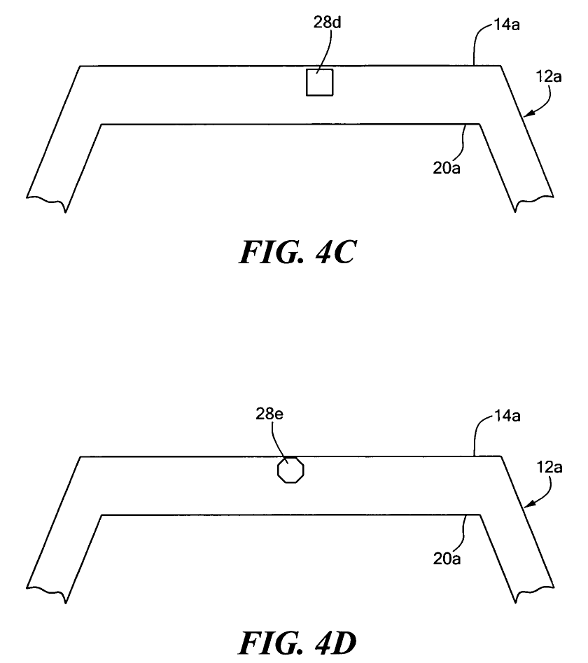

Although thus far the platform has been shown with a raised rib structure with the reinforcing elements disposed in them this is not a necessary limitation of the invention. For example, as shown in platform 12a, FIG. 4, reinforcing elements 28a may be imbedded directly in the platform and may as shown here be close to the lower surface 20a. Or elements 28b may be placed at the upper surface 14b. Or if platform 12a is thinner, or the reinforcing elements 28c are larger the reinforcing elements may be disposed in platform 14a so that they are near both the upper surface 14a and the lower surface 20a. Also although so far the reinforcing elements are shown as circular in cross sections this is a not a necessary limitation of the invention. The elements may have any suitable cross section, square 28d, octagonal 28e, triangular, hexagonal or any other random or regular form.

Although thus far the overmolding reinforcing elements have been shown integral and wholly encapsulated either in the body of platform 12 or in ribs 22 this is not a necessary limitation of the invention. For example, reinforcing elements 30, FIG. 5 include a first portion 32, which is anchored in platform 12b and a second portion 34 which extends out below surface 20b. Here the second portion 34 of the reinforcing elements 30 extend beyond surface 20b in the same manner as did ribs 22 in FIG. 3, but here they are not encapsulated where they protrude form surface 20b. Here too they have a rectangular cross section instead of round, actually a “T” cross section and again in this particular instance they are spaced from surface 14b giving improved resistance to bending.

Recycled polypropylene homopolymer material used in the platform has a much lower density than other plastics and exhibits excellent energy absorbence and aging properties as well as very good resistance to water, acids, oils and fuels. With chemical additives introduced in the material compounding process it may also be UV resistant and meets the VO standard for flame resistance. Thermoplastic molding produces products much more quickly and economically than typical thermoset or composite manufacturing processes, although these are still well within the scope of the invention. The material cures in a closed mold under pressure in less than 90 seconds and since it is at a relatively low temperature the cycle time can be quite high. The use of matched tooling and high molding pressures ensures a uniformly thick part with high tolerances. For this particular design where the deflection will be resisted by the reinforcing elements the low bending stiffness of the material is desirable in order to keep the skin stresses low. An additional benefit of this material is that it is readily available in very inexpensive recycled forms which may result in future cost reductions without compromising product performance. The characteristic properties of polypropylene homopolymer they can be used for the platform of this invention is shown in Table 1 where the characteristics have been expressed in metric units instead of English.

TABLE 1

| | | Purified |
|---|---|---|
| | Polypropylene Homopolymer | Fiberglass |
| Tensile Modulus (GPa) | 0.83 | 35 |
| Tensile Strength (Mpa) | 25 | 650 |
| Specific Gravity | 0.93 | 1.8 |

Typically, the reinforcing elements may be rectangular rods measuring 6.5 mm by 25 mm in a series of 7 mm wide and 40 cm deep and 40 mm deep channels. By moving mass away from the neutral bending plane the stiffness is increased by a factor of that distance squared as in conventional I-beam analysis. By increasing the rigidity of the top surface bowing is minimized as the load increases along the edge and stress is consequently transmitted into the side walls 16 of the platform. Typically the rods or reinforcing elements may be extruded or pultruded and disposed about 13 mm below the top surface and extending down to approximately 40 mm below the top. This allows stacking of the pads for easy shipment.

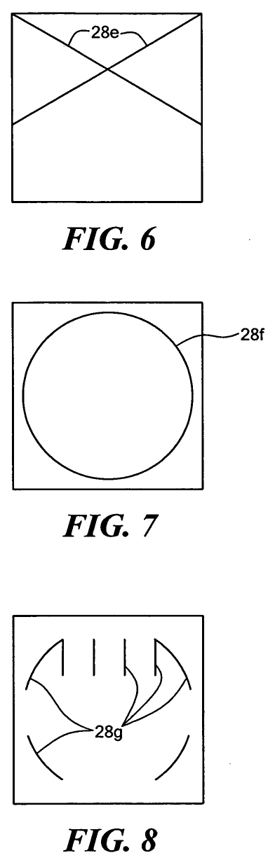

The particular rib array 24 shown in FIGS. 2 and 3 is not in any way limiting the invention. The one or more reinforcing elements as indicated may be placed in such prominent ribs or without such prominent ribs being present they may be placed directly in platform 12 between surface 14 and surface 20. In addition, the one or more reinforcing elements may be arranged in any desired pattern, for example, in a crisscross 28e arrangement, FIG. 6, a circular arrangement 28f, FIG. 7 or a combination of curves, arches and straight segments 28g, FIG. 8.

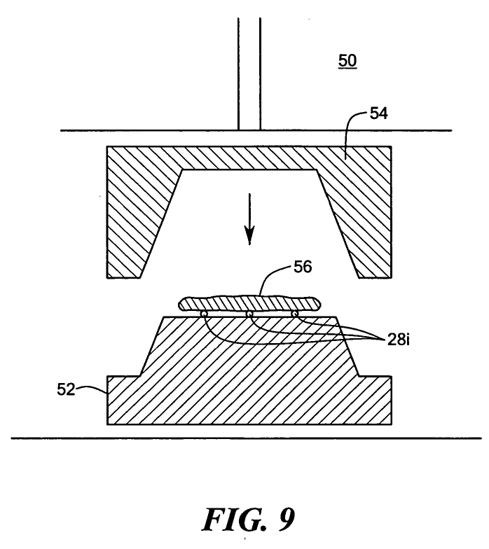

An important aspect of the invention is the improved molded reinforced pad for mounting electrical equipment which is made by an overmolding method of integrally forming and at least partially encapsulating the reinforcing elements in the platform. That method and the equipment for carrying it out are shown in FIG. 9 as including a mold 50, including a core 52 and a cavity 54. The method includes installing at least one or more reinforcing elements 28i, on core 52 and covering it with a charge of, for example, propylene homopolymer 56 and then bringing the heated cavity 54 and core 52 together under pressure to form the pad. The particular configuration of the pad, e.g. whether the reinforcing elements are housed in the body of the platform or in raised ribs is designed into the shape of the core and cavity to produce the desired shape for the final pad.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

1. A molded pad for mounting electrical equipment comprising:
a platform of a first material including polypropylene homopolymer, said platform having one surface for carrying electrical equipment; and
at least one reinforcing element of a second material integrally molded in said platform for increasing the stiffness and bending strength of said platform.

2. The molded pad of claim 1 in which said reinforcing elements and said platform each have an elastic modulus E, and tensile strength σ, and the elastic modulus E and the tensile strength σ of said reinforcing elements is higher than the elastic modulus E and the tensile strength σ said platform.

3. The molded pad of claim 1 in which said molded pad includes a rib structure on another surface of said platform with said at least one reinforcing element disposed in said rib structure.

4. The molded box pad of claim 1 in said support reinforcing element includes a first portion anchored in said platform and a second portion extending beyond the other surface of said platform.

5. The molded box pad of claim 1 in which said as least one reinforcing element is overmolded and at least partially encapsulated within said platform.

6. The molded pad of claim 1 in which said at least one reinforcing elements has a modulus of elasticity, E and tensile strength, σ, approximately two times or more than that of said platform.

7. The molded pad of claim 1 in which said at least one reinforcing elements has a modulus of elasticity, E and tensile strength, σ, approximately ten times or more than that of said platform.

8. The molded pad of claim 1 in which there are an array of reinforcing elements.

9. The molded pad of claim 3 in which said rib structure includes a matrix of ribs and an array of reinforcing elements are disposed therein.

10. The molded pad of claim 1 in which said polypropylene homopolymer first material includes recycled polypropylene homopolymer material.

11. The molded pad of claim 10 in which said first material is fiber reinforced.

12. The molded pad of claim 10 in which said first material includes filler material.

13. The molded pad of claim 1 in which said second material includes one of the groups consisting of thermoset plastic, thermoplastics, aluminum, kevlar, epoxy, graphite epoxy.

14. The molded pad of claim 1 in which said at least one reinforcing element is spaced from said one surface to increase bending stiffness.

15. An overmolding method of forming a pad for mounting electrical equipment comprising:
installing at least one reinforcing element in a mold;
adding a molding compound to form a platform; and
compressing the mold to overmold and integrally form and at least partially encapsulate said platform.

16. The overmolding method of forming a pad in claim 15 in which the mold is a compression match metal mold.

17. A molded pad for mounting electrical equipment comprising:
a platform of a first material having:
a first surface for carrying electrical equipment;
a second surface opposite said first surface, said second surface including ribs extending therefrom;
a base section; and
a wall between said base section and said second surface, said base section extending outward from said wall; and
at least one reinforcing element of a second material integrally molded in said ribs for increasing the stiffness and bending strength of said platform.
